(19) United States
(12) Patent Application Publication
(10) Pub. No.: US 2010/0070877 A1
(43) Pub. Date: Mar. 18, 2010

(54) SEAMLESS CONVERSION OF ORDINARY EMAIL DATA INTO CALENDAR DATA

(75) Inventors: Stacia SCOTT, Bellingham, WA (US); Oji UDEZUE, Sammamish, WA (US); Keith FOURNIER, Snoqualmie, WA (US); Eyal AXELROD, Redmond, WA (US); Ben CHUNG, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/212,567

(22) Filed: Sep. 17, 2008

(51) Int. Cl. G06F 3/048

(52) U.S. Cl. 715/751

(57) ABSTRACT

The claimed subject matter is directed to the conversion of ordinary email data into calendar data. Specifically, the claimed subject matter provides a method and system of an electronic communication message system that performs the creation of calendar events in a personal calendar application from electronic communication text. One embodiment of the claimed subject matter is implemented as a method for creating an electronic calendar event from a selected portion of text from electronic communication message. An electronic communication message is displayed to a user. A user selected portion of the text comprising the electronic communication message is received as input. A scheduling composition dialog is actuated based on the user selected portion, and a calendar event is created in a personal calendar application for the selected portion of the electronic communication message.

### BACKGROUND OF THE INVENTION

The use of electronic communication systems has become tremendously popular with the growth of the Internet and the development of mobile telecommunication devices. Popular examples of electronic communication include electronic mail (“email”), instant messaging (“IM”) and text messaging.

The term “e-mail” refers to a system for exchanging messages from one individual to one or more other individuals via telecommunication links between computers or terminals. Instant messaging (IM) is a form of real-time communication between two or more people based on typed text. The text is conveyed via computers connected over a network such as the Internet.

Text messaging is the common term for the sending of relatively short (limited to 160 or fewer characters) text messages from mobile phones using the Short Message Service (SMS). It is available on most digital mobile phones and some personal digital assistants with on-board wireless telecommunications. The individual messages are called text messages or, more colloquially, texts. Recently, advanced mobile devices have been developed to include email and instant messaging functionality.

Communication over electronic communication systems often includes the exchange of scheduling information, such as invitations to or notifications of engagements (e.g., events, meetings and appointments). Scheduling information for an engagement request may contain several elements such as (but not limited to): date, time, purpose, venue or location and frequency of recurrence.

Traditional techniques for schedule organization include manually adding an event or meeting and entering relevant details and elements into a calendar or date book. Calendar and scheduling software applications have been developed to add additional functionality and increase performance. However, current calendar and scheduling applications still require a user to manually create an event and add any content they wish to include. Accordingly, this process can become very labor-intensive and time-consuming as the number of scheduled engagements increases.

Engagement requests may be expressed among a broad range of formality, from the very unstructured (e.g., “meet me at 6 for a movie”), to the semi-structured (providing a majority of elements with reasonable clarity), and structured (formal meeting request). The lack of a dedicated structure adds to the challenge of automating scheduled engagements. A conventional solution to this challenge is the development of ICalendar (“iCal”) as a standard for electronically communicated calendar requests.

ICal has been integrated in many messaging and scheduling applications which use the iCal format to encapsulate and transfer scheduling information. However, to utilize iCal, both the sending application and the receiving application must understand the format. Moreover, the sending user must manipulate the application to generate an iCal data format which is attached to the message that is being sent. This often is realized as additional work flow for the user, and limits the solution to the applications which are compatible with the iCal format.

Unfortunately, conventional scheduling applications are typically unable to process unstructured or semi-structured engagement requests (i.e., the requests without iCal attachments), and the use of the iCal format is still relatively rare. The vast majority of engagement requests is still communicated through unstructured or semi-structured messages. Users typically circumvent the additional effort required to create a formal engagement request with iCal and persist in simply sending an informal message in the hope that the recipient will translate the message accurately into whatever personal organizing platform they use.

Given the low adoption of the iCal format by users who exchange scheduling information in their day to day messages, a substantial portion of scheduling information in messaging systems remains disconnected from the personal electronic calendar of corresponding users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The claimed subject matter is directed a method and system for the automated conversion of ordinary email data in calendar data. The claimed subject matter provides a method for manually converting a selected portion of electronic communication text into a calendar event entry in a personal calendar application. Another embodiment of the claimed subject matter provides a method for automatic conversion of electronic communication text into calendar event entries in a personal calendar application.

In one embodiment, a user is able to directly create in a personal calendar application a calendar event from a selected portion of electronic communication text via a toolbar or context menu. In certain cases, it will be possible to further simplify the calendar event creation by analyzing the content of the message with a text parser and inputting the information into the created calendar event. The resultant scheduling composition dialog already has all the desired information included (duration field, location, etc.) as a result of this analysis.

In another embodiment, the conversion of a message to an electronic event without the use of a toolbar or message level control is available. In this mode, all the text in a message that is related to a scheduling event is automatically detected and differentiated from the rest of the content in some way, for example, highlighted. The type of text related to scheduling can be one or more of the following type (date, place, duration, reoccurrence). This detection will be done using the parsing technique described above.

In a still further embodiment a completely automatic mode of operation, where the software is configured to convert all messages that contain scheduling information into a calendar event is provided.

### BRIEF DESCRIPTION OF THE DRAWINGS

FIG. 1 is a flowchart describing the process of manually adding a calendar event from electronic communication message to a personal scheduling application, in accordance with various embodiments of the claimed subject matter;

FIG. 2 is a flowchart describing the process of automatically adding a calendar event from electronic communication message to a personal scheduling application, in accordance with various embodiments of the claimed subject matter;

FIG. 3 is an illustration of an exemplary context menu actuated to convert a calendar event from electronic communication message to a personal scheduling application, in accordance with various embodiments of the claimed subject matter;

FIG. 4 is an illustration of an electronic communication message interface of an exemplary electronic communication application with a context menu actuated to convert a calendar event from electronic communication message to a personal scheduling application, in accordance with various embodiments of the claimed subject matter;

FIG. 5 is an illustration of an alternate interface of an exemplary electronic communication application with a tool bar to convert a calendar event from electronic communication message to a personal scheduling application, in accordance with various embodiments of the claimed subject matter; and

FIG. 6 shows an exemplary computing device according to various embodiments.

### DETAILED DESCRIPTION

Reference will now be made in detail to the preferred embodiments of the claimed subject matter, a method and system for the use of a reputation service provider, examples of which are illustrated in the accompanying drawings. While the claimed subject matter will be described in conjunction with the preferred embodiments, it will be understood that they are not intended to be limit to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Accordingly, embodiments of the claimed subject matter provide a method and system for the automated conversion of ordinary email data in calendar data. The claimed subject matter provides a method for manually converting a selected portion of electronic communication text into a calendar event entry in a personal calendar application. Another embodiment of the claimed subject matter provides a method for automatic conversion of electronic communication text into calendar event entries in a personal calendar application. Embodiments of the claimed subject matter and its benefits are further described below.

### Manual Conversion

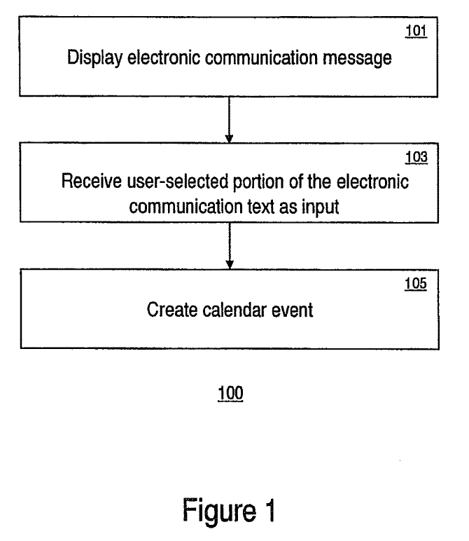

FIG. 1 is a flowchart describing the process 100 of manually adding a calendar event from electronic communication message to a personal scheduling application, in accordance with various embodiments of the claimed subject matter. Steps 101-107 describe exemplary steps comprising the process 100 in accordance with the various embodiments herein described.

According to the process 100 of FIG. 1, an electronic communication message is displayed to a user at step 101. The electronic communication message may comprise, for example, an email, an instant message, a text message, or other text-inclusive communication transmitted electronically. In one embodiment, the electronic communication message is displayed in an email management software application. In alternate embodiments, the electronic communication message may be displayed in an instant messaging or text messaging interface instantiated on a computing device, or a mobile computing device. In some embodiments, the specific electronic communication message may be displayed either alone, or with other like units of electronic communication message in concert.

At step 103, a selection of a portion of text comprising the electronic communication message is received as input. In one embodiment, the selection is a user-selected portion of the text. Selection may be achieved by, for example, highlighting a desired portion of text. Other interface-specific methods for distinguishing or selecting a portion of text may be used as well. For example, a popular feature in many word-processing applications allows a user to highlight an entire word by actuating a visual pointer (e.g., a mouse pointer) over a portion (character) of the word.

In one embodiment, once the selected portion of text comprising the electronic communication message is registered, a scheduling composition dialog may be actuated for the selected portion. The scheduling composition dialog may, for example, comprise a selectable entry in a graphical menu instantiated proximate to the selected portion of text. Activating the scheduling composition dialog automatically adds the selected portion of text to a personal electronic calendar. In alternate embodiments, in lieu of a scheduling composition dialog, a selectable tool (e.g., an action button) in a toolbar presented in the interface used to display the electronic communication message may be activated to create a calendar event without displaying the composition dialog.

In one embodiment, the personal electronic calendar is a pre-defined calendar application. In other embodiments, if an eligible calendar application (e.g., a calendar application supporting the manual conversion feature) has yet to be defined prior to an actuation of the scheduling composition dialog for a selected portion of text, the user is prompted to specify an eligible calendar application. In further embodiments, a list of eligible calendar applications is generated and presented to the user for selection. In still further embodiments, if no calendar application has been pre-selected prior to an actuation of the scheduling composition dialog, the selected portion of text is added to a default calendar application.

At step 105, once a user has activated the selectable entry in a graphical menu to add the calendar event to the user's personal calendar, a corresponding calendar event is created in the user's designated personal calendar application (or default personal calendar application). In alternate embodiments, a use may add a calendar event to a personal calendar without actuating the scheduling composition dialog by activating a tool or other such function on a toolbar or similar interface. The calendar event is created containing information from the originating electronic communication message. In a typical personal calendar application, a calendar event may contain a title field (typically a descriptive line or phrase of the underlying event) and a body field (which includes the particular details of the event). In one embodiment, portions of the electronic communication message are repurposed (e.g., transposed) as the title and body fields.

According to one embodiment, the text comprising a created calendar event is formatted as plain text. In further embodiments, if the text comprising originating electronic communication message is of a format other than plain text, (e.g., HTML), any portions of the text which are repurposed and included in the created calendar application are converted into plain text during the calendar event creation process at step 105.

For example, the subject line of an email may be repurposed as the title field of the created calendar event and the content of the message may be repurposed as the details in the body fields. In further embodiments, only the portion of the electronic communication message selected by the user and received in step 103 is repurposed as the body fields. In still further embodiments, the electronic communication message is scanned and parsed to identify scheduling elements (e.g., time, date, venue, frequency, etc.), and the identified scheduling elements are repurposed as the body fields of the created calendar event.

After the calendar event is created in the personal calendar application, the user is able to modify the contents of the entry. For example, the user may edit the title and body fields of the created calendar event with other information contained in the electronic communication message.

In still further embodiments, the user is able to encode the calendar event as an iCal file, which can be sent to other specified users according to the features of the iCal standard. Finally, the user is able to store the manually created calendar event in the personal calendar application.

### Automatic Conversion

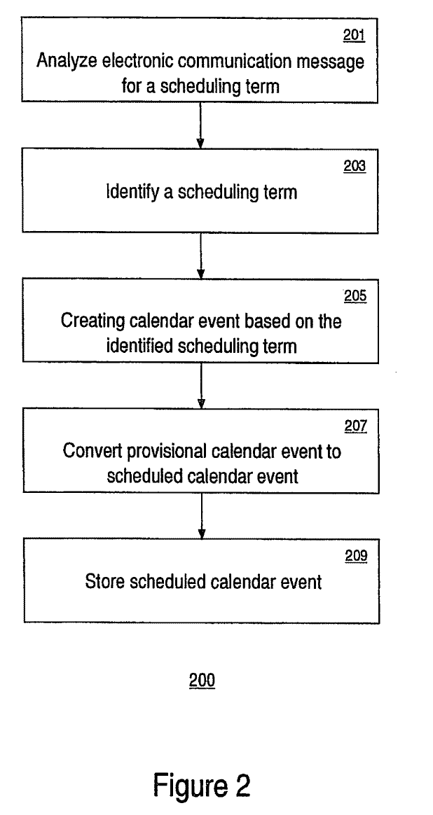

FIG. 2 is a flowchart describing the process 200 of automatically adding a calendar event from electronic communication message to a personal scheduling application, in accordance with various embodiments of the claimed subject matter. Steps 201-209 describe exemplary steps comprising the process 200 in accordance with the various embodiments herein described.

According to the process 200 of FIG. 2, an electronic communication message is analyzed for a scheduling term at step 201. The electronic communication message may be analyzed for example, by a text parser once the display of the electronic communication message has been actuated by a user. The electronic communication message may comprise, for example, an email, an instant message, a text message, or other text-inclusive communication transmitted electronically. In one embodiment, the electronic communication message is displayed in an email management software application. In alternate embodiments, the electronic communication message may be displayed in an instant messaging or text messaging interface instantiated on a computing device, or a mobile computing device.

In some embodiments, the specific electronic communication message may be displayed either alone, or with other like units of electronic communication message in concert. Analyzing the scheduling term may comprise, for example, scanning the electronic communication message and parsing the text to identify scheduling elements (e.g., time, date, venue, frequency, etc.). In still further embodiments, a user is able to set a control (e.g., a toggle) so that every received electronic communication message is analyzed and processed automatically to add a calendar event (where applicable) prior to an actuation of a display. For example, the electronic communication message application may automatically process each electronic communication message as the message is received.

At step 203, a scheduling term is identified by the text parser. Scheduling terms may consist of a formal scheduling term, such as, “Feb. 20, 2000.” Scheduling terms may also be extrapolated from abbreviated or known colloquial terms for scheduling terms. For example, dates may be identified as scheduling terms according to numerical layout (e.g., Feb. 20, 2000 or Feb. 20, 2000 for the date referenced above) or a mixture of both abbreviated text and numbers (e.g., Feb. 20, 2000). Other examples include colloquial expressions (e.g., “today” or “tomorrow”). In one embodiment, the text parser is communicatively coupled to a storage component having a database of known abbreviates and/or popular venues. Where a scheduling term is not identifiable to a minimum threshold of certainty, the text parser may present the user a generated list of the best approximations, and query the user for the correct and/or preferred selection.

At step 205, a calendar event is created in a personal calendar application for the electronic communication message based on the identified scheduling term. In one embodiment, the text parser used to analyze the electronic communication message in step 201 is able to recognize well formed and not so well formed date fields within the content of the message. In addition, the parser can also determine which text in the message refers to the location of the event (especially in the case of well formed scheduling emails, such as from event subscriptions) and the duration, and frequency of recurrence of the event. This analysis is used to automatically create a calendar event with the determined time frame (e.g., the start and/or end time for the calendar even) as well as the location and the duration.

According to one embodiment, the text comprising a provisionally created calendar event is formatted as plain text. In further embodiments, if the text comprising the originating electronic communication message is of a format other than plain text, (e.g., HTML), any portions of the text which are repurposed and included in the provisionally created calendar application are converted into plain text during the calendar event creation process of step 205.

In order to account for possible false positives in this completely automatic mode, one embodiment might also differentiate between automatically created calendar events and events created manually or imported from an iCal. These automatically created events may be set according to different visible indicia (for example, a lighter color) or be stored differently (tentative appointment store) in order to be much more ephemeral than manually created events. In essence, each automatically created event has to be validated or promoted to a “real” event. As a class of event, as a matter of convenience, it should be possible to hide all of them, change them to real events, delete them, etc. Essentially, to act on them as a group or individually.

At step 207, a user may opt to “convert” or “ratify” a automatically created provisional calendar event to a real or manually created calendar event, so as to remove the distinguishing characteristic(s) of a provisional calendar event from the ratified calendar event. The user is then able to use one of the differentiated text snippets (e.g., highlighted, underlined, etc.) to add an event to a personal electronic calendar. This can be done using any of the usual methods (right click, pop up options on a mouse (mouse driven UI) or touch (touch screen).

For example, provisional calendar events in one personal calendar application may be displayed having green font, whereas manually created calendar events in the same personal calendar application may be displayed with a normal black font. By ratifying a provisional calendar event, the user is able to alter the font of the provisional calendar event from green to black. In further embodiments, the user may be able to select a plurality of provisional calendar events to convert to manually created calendar events. In still further embodiments, the user may be able to automate the conversion process. For example, the user may be able to define controls and refine the automatic operation of this conversion process.

A possible manifestation of this user control component includes and is not limited to: a configuration or option dialog for controlling the automatic operation; specific controls on the configuration dialog that indicate what the threshold of a message should be before converting the provisional calendar event into a manually created calendar event; and Specific choices on how automatically created events will be differentiated from events that are manually created or imported from iCal files such that only the electronic communication messages which share a common characteristic may be automatically promoted. For instance, a user may elect to convert all calendar dates created from an electronic communication message sent from a specific address (e.g., email address or phone number). Other controls may include, for example, converting all provisional calendar events created within a certain range of dates.

Finally, the scheduled calendar event is stored in the personal calendar application of the user at step 209. The scheduled calendar event may be stored as a provisional calendar event, or as a manually created calendar event, as specified by the user in step 207. In further embodiments, the scheduled calendar event may also encode each created calendar event (either provisional or manual) in iCal format, which can be exchanged with other users of the electronic communication application or platform.

### Exemplary Scheduling Composition Dialog

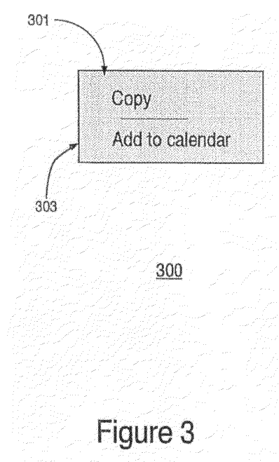

FIG. 3 is an illustration of an exemplary context menu 300 actuated to convert a calendar event from electronic communication message to a personal scheduling application, in accordance with various embodiments of the claimed subject matter. In a typical configuration, context menu 300 includes action buttons (e.g. “Copy” button 301, “Add to calendar” button 303).

Context menu 300 may for example, comprise the scheduling composition dialog actuated by a user during the process 100 as described above. In one embodiment, specifying (e.g., highlighting) a section or portion of text comprising an electronic communication message automatically generates a display of the context menu 300. The user is able to select one of the action buttons displayed in context menu 300 to perform. For example, the user may temporarily store a copy of the selected text by selecting the Copy button 301. Alternatively, the user is able to create a calendar event for the selected portion of the electronic communication message by actuating the Add to calendar button 303.

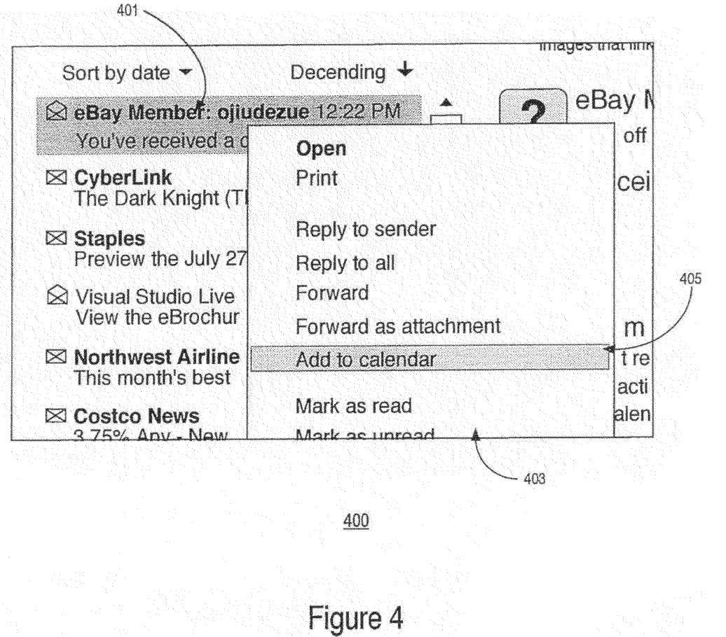

FIG. 4 is an illustration of an electronic communication message interface 400 of an exemplary electronic communication application with a context menu actuated to convert a calendar event from electronic communication message to a personal scheduling application, in accordance with various embodiments of the claimed subject matter. In a typical configuration, electronic communication message interface 400 includes a list of electronic communication messages 401, and a context menu 403 which includes action buttons (e.g., “Add to calendar” button 405).

As depicted in FIG. 4, electronic communication message interface 400 depicts a list of a plurality of electronic communication messages 401, wherein the source (e.g., sender) and title of the message is displayed, but the rest of the content of the message is not shown. In one embodiment, selecting the listing of an electronic communication message displays the entirety of the message in a separate field or window. According to further embodiments, selecting a portion of an electronic communication message (or other actuation such as, for example, right-clicking a mouse pointer) generates a display of a context menu 403 which allows the operating user the ability to perform a variety of functions with respect to the electronic communication message.

Typically available functions include options to “Open,” “Print,” “Forward,” and “Reply.” In a typical configuration, each function is presented in a separate action button, and may be performed by activating the actuation point (e.g., action button) of the function. In one embodiment, actuating a context menu 403 includes the Add to Calendar action button 405, which, when activated, allows a user to create an event in a personal calendar application for the selected portion of text. In further embodiments, a user is able to initialize the automatic processing of creating calendar events by parsing an electronic communication message for scheduling terms by activating the Add to calendar button for the message.

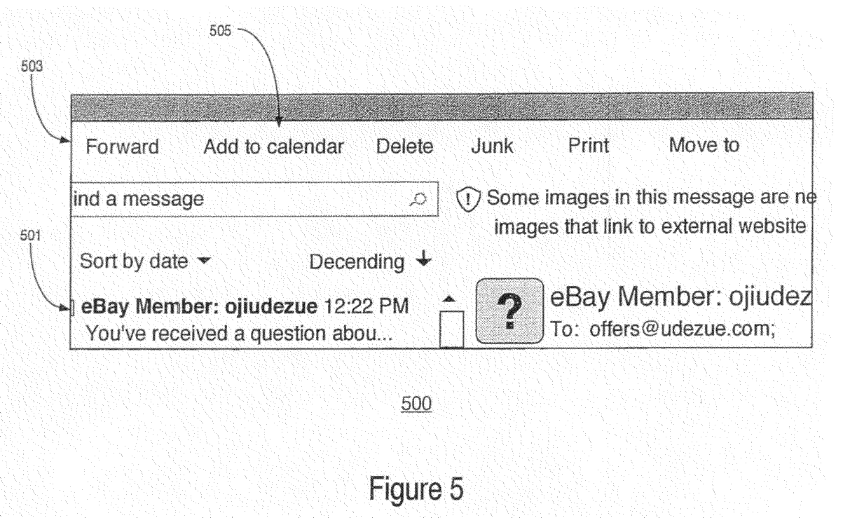

FIG. 5 is an illustration of an alternate electronic communication message interface 500 of an exemplary electronic communication application with a tool bar to convert a calendar event from electronic communication message to a personal scheduling application, in accordance with various embodiments of the claimed subject matter. In a typical configuration, alternate electronic communication message interface 500 a list of electronic communication messages 501, a toolbar 503 comprising a plurality of action buttons (e.g., “Add to Calendar” button 505).

As depicted in FIG. 5, electronic communication message interface 500 depicts a list of a plurality of electronic communication messages 501, wherein the source (e.g., sender) and title of the message is displayed, but the rest of the content of the message is not shown. In one embodiment, selecting the listing of an electronic communication message displays the entirety of the message in a separate field or window. According to further embodiments, a user is able to perform actions to an electronic communication message or a selected portion of an electronic communication message by activating an action button in the toolbar 503. Activation may be performed by, for example, clicking via a mouse pointer).

Typically available functions include options to “Forward,” “Delete,” “Print,” and “Move.” In a typical configuration, each function is presented in a separate action button in toolbar 503, and may be performed by activating the actuation point (e.g., action button) of the function. In one embodiment, toolbar 503 includes the Add to Calendar action button 505, which, when activated, allows a user to create an event in a personal calendar application for the selected portion of text. In further embodiments, a user is able to set controls for the automatic processing of creating calendar events by parsing an electronic communication message for scheduling terms by activating the Add to calendar button for the electronic communication message interface 500.

### Basic Computing Device

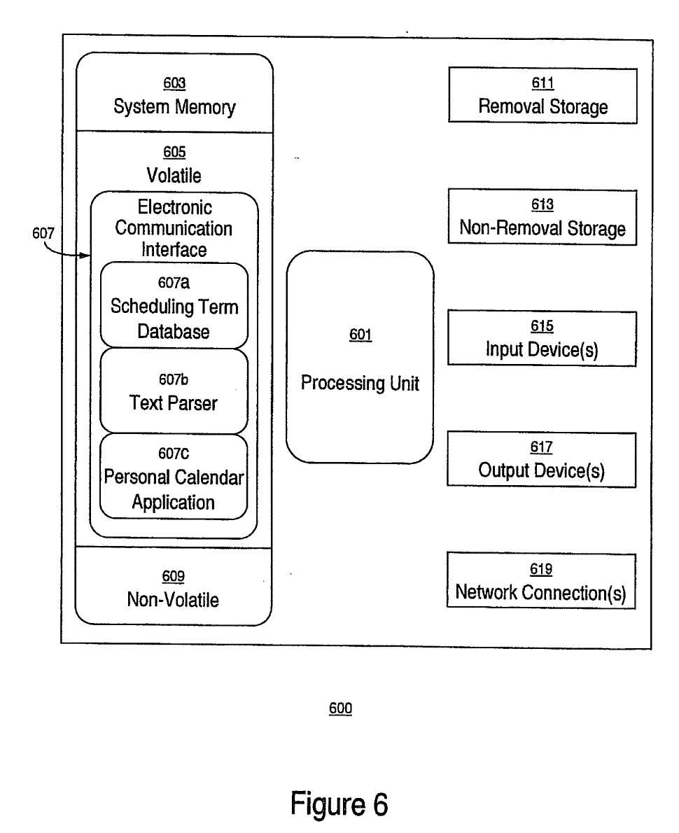

FIG. 6 shows an exemplary computing device 600 according to various embodiments. Computing device 600 depicts the components of a basic computer system providing the execution platform for certain software-based functionality in accordance with various embodiments. Computing device 600 can be an environment upon which an electronic communication interface from various embodiments is instantiated. In addition, computer device 600 can be an environment upon which a display of electronic communication message applications and personal calendar applications are implemented, for example.

Computing device 600 can be implemented as, for example, a desktop computer system, laptop computer system or server computer system. Similarly, computing device 600 can be implemented as a handheld device (e.g., cell-phone, etc.) Computing device 600 typically includes at least some form of computer readable media. Computer readable media can be a number of different types of available media that can be accessed by computing device 600 and can include, but is not limited to, computer storage media.

In its most basic configuration, computing device 600 typically includes processing unit 601 and memory 603. Depending on the exact configuration and type of computing device 600 that is used, memory 603 can be volatile (such as RAM) 605, non-volatile 609 (such as ROM, flash memory, etc.) or some combination of the two. In one embodiment, electronic communication message interface 607 is instantiated in the volatile memory 605. Electronic communication interface 607 may include scheduling term database 607a, which contains the possible scheduling terms which may be used within an electronic communication message. Storage component 607 may also include text parser 607b, comprising a text parser used to analyze electronic communication messages in electronic communication message interface 607. In addition, electronic communication interface 607 may include personal calendar application 607c, which stores an electronic calendar and any scheduled calendar events. In alternative embodiments, electronic communication interface 607 and its underlying components may be implemented in whole or in part in non-volatile memory 609.

Additionally, computing device 600 can include mass storage systems (removable 611 and/or non-removable 613) such as magnetic or optical disks or tape. Similarly, computing device 600 can include input devices 615 and/or output devices 617 (e.g., such as a display). Additionally, computing device 600 can include network connections 619 to other devices, computers, networks, servers, etc. using either wired or wireless media. As all of these devices are well known in the art, they need not be discussed in detail.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for creating an electronic calendar event from an electronic communication message, comprising:
displaying an electronic communication message to a user, the electronic communication message having a subject and a body;
receiving as input a user-selection of a portion of text comprising the electronic communication message; and
creating a calendar event in an personal calendar application, wherein the calendar event is based on the user-selection.

2. The method of claim 1, wherein receiving as input a user-selection further comprises actuating a scheduling composition dialog for the user-selection.

3. The method of claim 1, wherein creating a calendar event comprises generating a scheduled event having a title and details, wherein the title and details comprise a portion of text from the electronic communication message.

4. The method of claim 3, wherein generating a scheduled event further comprises repurposing a subject line of the electronic communication message as the title of the scheduled event.

5. The method of claim 3, wherein generating a scheduled event further comprises repurposing content of the electronic communication message as details of the scheduled event.

6. The method of claim 3, further comprising:
receiving as input from a user additional information for the scheduled event; and
adding the additional information received as input to the details of the scheduled event.

7. The method of claim 1, further comprising encoding the calendar event as an ical file

8. The method of claim 1, further comprising storing the calendar event in the personal calendar application.

9. A method for automatically converting electronic communication message into calendar data, the method comprising:
analyzing an electronic communication message for a scheduling term;
identifying a scheduling term in the electronic communication message; and
automatically creating a calendar event in an personal calendar
application based on a resulting identified scheduling term.

10. The method of claim 9, wherein automatically creating a calendar event in an personal calendar application comprises automatically creating a provisional calendar event visibly distinguishable from scheduled calendar events.

11. The method of claim 10, further comprising:
converting the provisional calendar event in to a scheduled calendar event based on user input; and
storing the scheduled calendar event in the personal calendar application

12. The method of claim 9, wherein analyzing electronic communication message comprises parsing the electronic communication message for a scheduling term.

13. The method of claim 12, wherein parsing the electronic communication message comprises recognizing a portion of the electronic communication message as reference to a scheduling term.

14. The method of claim 13, wherein the scheduling term is from a group of scheduling terms comprising: date, time, location, venue, duration, frequency; wherein the calendar event is created for the scheduling term.

15. A computer readable media having computer executable components to implement an electronic communication system, comprising:
an electronic communication interface for displaying an electronic text communication to a user;
a screen reader for registering user input applied through the electronic communication interface;
an input recorder for recording the input from the screen reader, wherein, the input from the screen reader is used to create a unit of scheduling in a personal calendar application, wherein the unit of scheduling is created in a personal calendar application and comprises text from the electronic text communication.

16. The electronic communication system of claim 15, the electronic communication system further comprising:
a text parser for analyzing received electronic text communication; and
a storage component for storing a unit of scheduling in the personal calendar application,

17. The electronic communication system of claim 15, wherein the electronic text communication is an email.

18. The electronic communication system of claim 15, wherein the electronic text communication is an instant message in an electronic messaging application.

19. The electronic communication system of claim 15, wherein the electronic text communication is a multimedia messaging service message.

20. The electronic communication system of claim 15, wherein the electronic text communication is a short messaging service message.
